(19) United States
(12) Patent Application Publication
(10) Pub. No.: US 2018/0157535 A1
(43) Pub. Date: Jun. 7, 2018

(54) METHODS, SYSTEMS AND APPARATUSES FOR MANAGING PRIORITIZATION OF TIME-BASED PROCESSES

(71) Applicant: Datto, Inc., Norwalk, CT (US)

(72) Inventor: David DUSHOK, Bridgeport, CT (US)

(21) Appl. No.: 15/737,162

(22) PCT Filed: Jun. 15, 2016
(86) PCT No.: PCT/US16/37696

§ 371 Date: Dec. 15, 2017

Related U.S. Application Data
(60) Provisional application No. 62/175,669, filed on Jun. 15, 2015.

(51) Int. Cl. G06F 9/50; G06F 9/48; G06F 11/34

(52) U.S. Cl. CPC G06F 9/5038; G06F 2209/5019; G06F 11/3433; G06F 9/485

(57) ABSTRACT

The METHODS. SYSTEMS AND APPARATUSES FOR MANAGING PRIORITIZATION OF TIME-BASED PROCESSES. (“STS”) receive scheduled processor-executable tasks from users connected to a production network through a computer network. The STS system can analyze the tasks before execution to determine expected system resources that will be consumed by the tasks during their execution. The STS system performs a multi-objective optimization to group tasks in sets suitable for parallel execution and to determine an optimal execution order to execute the sets of tasks at a scheduled time. Each scheduled task can perform one or more operations in a target compute device, a slave computer device or other suitable computer devices located in the computer network.

The present application claims a priority benefit to U.S. Provisional Application Ser. No. 62/175,669, filed Jun. 15, 2015, entitled “METHODS, SYSTEMS AND APPARATUSES FOR MANAGING PRIORITIZATION OF TIME-BASED PROCESSES,” which application is hereby incorporated by reference herein in its entirety.

### BACKGROUND

Time-based task schedulers are typically employed by system administrators to configure scheduled tasks at a specific time, date, and/or on-going basis at a specific interval. Examples of time-based task schedulers include Cron in Unix-like operating systems and Task-Scheduler in Windows operating systems. Examples of these tasks include regular daily backups, periodic mail checking, polling a device for input, and sending regular reports to one or more computing devices.

Time-based schedulers are usually agnostic with respect to the tasks they deploy and the computational load handled by target devices. The main function of a typical time-based scheduler is to deploy a task for execution at an indicated scheduled time. Time-based task schedulers are generally unaware of the computational expense incurred by target devices before and at the time of the task execution. Accordingly, time-based schedulers deploy tasks based on their configured schedule but miss opportunities to optimize the execution of these tasks.

A significant advantage of using time-based task schedulers is the ability to execute tasks at a determined time. Thus, system administrators can rely on scheduled tasks to be executed at convenient times, for example, at times when it is less likely to affect the productivity or workflow of a production computer network such as, during nonbusiness hours or during non-peak production hours. Although, system administrators can sometimes times predict accurately the time when a task is more likely to be successfully executed by a target device, this prediction usually does not account for emergent network or target device properties that may prevent the execution of a task at the scheduled time.

### SUMMARY

The inventor has recognized several limitations in conventional time-based schedulers that can affect the productivity of a computer system. For example, conventional time-based schedulers are generally unaware of their production environment and the amount of computational resources required by a target device to execute a scheduled task. These time-based schedulers deploy tasks to target devices rigidly at the scheduled time and lack information or logic to predict whether or not a target device can execute one or more of the deployed tasks. Thus, the execution of tasks may be constrained by susceptible system failures due to the potential overload of a target computing device resources or other similar issues.

The risks of overloading target device resources can be mitigated by generating in real-time or near real-time the order and the combination of scheduled tasks that are scheduled for deployment at a given time. The real-time determination of an order, combinations and permutations of tasks can be based on the assessment of information regarding the computational expense required to execute one or more scheduled tasks, the load handled by the target device before the task is deployed and other similar information and metrics relevant to the optimization, of the deployment of scheduled tasks and their execution at target devices.

Some additional limitations of basic time-based schedulers identified by the inventor include the requisite to configure time-based schedulers through shell commands demanding users to have an understanding of operative systems commands and thus, narrowing the pool of users capable to configure scheduled tasks. With respect to the history of deployed and executed tasks, the inventor recognizes that some basic time-based schedulers keep log files associated with the tasks been deployed and their execution outcome. However, many times, the number of log files can grow rapidly over time, often making these files difficult to maintain and monitor. For example, a time-based scheduler can register the execution of tasks by appending an entry to a log file or creating a new log file. Keeping track of the executed tasks in such a way can generate an ever growing file repository that is not only difficult to prune, and search, but also could rapidly fill up a system storage memory when it is left unsupervised.

Embodiments of the present invention include methods, systems, and apparatuses to manage the prioritization of time-based tasks that address the shortcomings of conventional time-based task schedulers. In some implementations, a scheduler server in a trusted network receives one or more tasks with computer executable instructions, or computer interpretable instructions to perform multiple operations on target computing devices located in a trusted network or in an untrusted network. The tasks with the computer executable instructions, and/or interpretable instructions can be sent by a user in communication with a computing device or terminal connected to an untrusted network.

In some implementations, the scheduler server can estimate the resources that are consumed by each task during their execution or interpretation. For example, upon reception of a task configuration request, the scheduler server can emulate the execution or interpretation of the task's instructions and generate a task profile according to expected usage metric values of a target device in relation to a scheduled task, or potential security issues. For example, the execution of the task may cause a target device to consume memory or central processing unit (CPU) usage beyond its capacity at a scheduled time, this type of information can be captured in the task profile or expected usage metrics. In some instances, the task profile can include the computational expense of the task by itself independent of a target device. For example, the task scheduler can parse the instructions included in the task and calculate a corresponding algorithmic computational expense by measuring the frequency of instructions or operations known to be inexpensive (e.g., comparisons of values) and the frequency of instructions or operations known to be expensive (e.g., square roots, multiplications and other equal or more complex computations). In some additional or alternative implementations, the task profile can include the computational expense of a task as a function of the resources of a target device. In yet some further implementations, the task profile can be updated over time. For example, the task scheduler can capture usage metrics associated with one or more resources used by a target device during the execution of a scheduled task. Thus, any decline or improvement of the target device performance can be monitored and recorded, for example, each time a task is deployed and executed by a target device. The performance of a target device can decline over time due to hardware deterioration, in such a case the scheduler server can update as required a task profile associated with an affected target device. For another example the performance of a target device can be improved due to software or hardware upgrades and similarly the scheduler server can update a task profile associated with the target device.

In some instances, the scheduler server can make informed decisions in real-time or near real-time during or before the deployment of scheduled tasks to determine and prevent potential performance and security issues in a production computer network that can be caused by, for example, overscheduling or overloading a target device in the production network or by executing unsecure operations.

In some implementations, the scheduler server can have a thread or daemon process running on the background to monitor sets of tasks that are scheduled to be executed and/or interpreted at a near-future time period. The scheduler server can determine one or more combinations and/or permutations of tasks to be executed in parallel by a target device. The combinations and/or permutations can be organized in sets containing one or more tasks, the sets can be further organized in an optimized order according to a multi-objective optimization analysis, reconciling competing objectives. For example, one objective can be to process efficiently the highest number of tasks, a second objective can be constraining memory and CPU usage according to usage limits or thresholds specified in one or more global rules. Once an optimized execution order is determined a daemon or background process can the sets of tasks to target device(s) for the parallel execution of the tasks included in each set.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a cross-entity data flow illustrating a user scheduling a task, and a scheduler task server (STS) receiving and profiling the scheduled tasks, in one embodiment.

FIG. 2 shows a cross-entity data flow illustrating further aspects of the processes executed by the STS in FIG. 1, in one embodiment.

FIG. 3 shows a logic flow illustrating further aspects of the process shown in FIG. 2, in one embodiment.

FIGS. 4A-D show examples of plots illustrating random access memory (RAM) resources consumed by a target compute device throughout the execution of four different scheduled tasks, in one embodiment.

FIGS. 5A-C show examples of plots illustrating central processing unit (CPU) resources consumed by a target compute device throughout the execution of three different scheduled tasks, in one embodiment.

FIG. 6 shows an example of global rules and a multi-objective optimization technique utilized as control strategy to command the deployment for the parallel execution of scheduled tasks, in one embodiment.

FIG. 7 shows an embodiment of a graphical user interface displaying a folder structure to schedule a task to be processed by the STS shown in FIG. 1.

FIG. 8 shows another embodiment of a graphical user interface displaying scheduled tasks contained inside a folder as the ones presented in FIG. 7.

FIG. 9 shows a production computer network receiving a scheduled task from a user on an untrusted network, in one embodiment.

FIG. to shows an example of system components of a client computer device or terminal computer device, in one embodiment.

FIG. 11 shows an example of system components of a slave computer device, in one embodiment.

FIG. 12 shows an example block diagram illustrating further aspects of the Scheduler Task Server, in one embodiment.

### DETAILED DESCRIPTION

### Introduction

In some embodiments, METHODS, SYSTEMS AND APPARATUSES FOR MANAGING PRIORITIZATION OF TIME-BASED PROCESSES, (hereinafter Scheduler Task Server “STS”) enables the deployment of tasks to target devices in a production computer network according to an optimized execution order. The tasks can specify the execution order of one or more computer operations to be performed at one or more specific times on target computer devices located outside the boundaries of a trusted network or within the trusted network.

In some implementations a STS can determine expected consumption of target device resources, for example, CPU and RAM resources usage per task; peak CPU and RAM usage; CPU and RAM usage as a function of time; and similar types of performance metrics. The STS can also monitor the current computational load target devices handle in real-time or near real-time. Accordingly, the STS can utilize this information to efficiently plan in real-time or near real-time the optimized deployment of tasks to target devices for their effective execution. In some implementations, the execution order of tasks can be organized based on criteria such as, a target device available memory (e.g., RAM), the predicted time to execute a task, latent security issues, and actual consumption of resources as recorded by the STS from previous executions of a task on a target device and/or an emulated or simulated execution of a scheduled task. For example, the execution of a task can cause a target device to consume a constant number of resources. For another example, the execution of a task can cause a target device to initially consume resources at a high rate and then at certain point of the execution time the target device can start releasing resources exponentially, or consuming resources at a constant rate over time. These task resource consumption characteristics or properties can be monitored, measured and recorded by the STS in a task profile.

In some implementations, the STS can use the information in the task profiles, and monitor the computational load handled by target devices before the deployment of tasks. Accordingly, the STS can determine an optimized execution order to increase the rate of successfully executed tasks. In some further implementations, the STS can send feedback to a user regarding the execution, failure, or completion of a scheduled task.

In some implementations, the STS utilizes a Smart Load Balance (SLB) component to determine an execution order based on multi-objective optimization technique facilitating the parallel execution of tasks in a target device. The multi-objective optimization technique can reconcile multiple competing objectives including but not limited to reducing or minimizing execution time per scheduled period, increasing or maximizing task execution efficiency, reducing or minimizing resources consumed by tasks executed in parallel and/or maximizing the number of tasks to be executed per scheduled period.

An STS can also preemptively determine potential security issues that can emerge before, during or as a result of the execution of scheduled tasks. For example, the STS can emulate or simulate a scheduled task before performing the task to determine whether performing the task can create potential security issues, such as a call to an unsecure URL that may cause a data breach. For another example, the STS can determine potential security issues by parsing the code of a scheduled task before its deployment. If the STS system detects such a call and/or other security issues during emulation of the task, the inspection of the task code, or the execution of a task, the STS system can notify to a user, system administrator during, or a non-person entity before or instead of deploying the task.

Because the STS system can screen for potential security issues, it can be used to receive and execute scheduled tasks from multiple users on trusted and untrusted networks. In addition, users on the untrusted networks do not need to be concerned about over-scheduling or overloading target devices resources because the STS system uses SLB as described above and below.

In one example, an STS system can include a graphical user interface (GUI) that enables a user to schedule tasks in the form of source code, scripts, computer executable files, computer interpretable files or other suitable digital data. In some instances, the GUI enables the user to drag and drop elements representing the tasks into folders in a folder structure. Each folder in the folder structure can be labeled with an execution time, for example, every 30 seconds, hourly, Mondays at 9:00 AM, or other suitable indicators. The labels can indicate a time when a task is configured to be executed. A task that is dropped under a folder labeled as “30 seconds” can be executed every 30 seconds. Alternatively, a user can use shell commands to configure a scheduled task.

### Scheduling and Executing Tasks

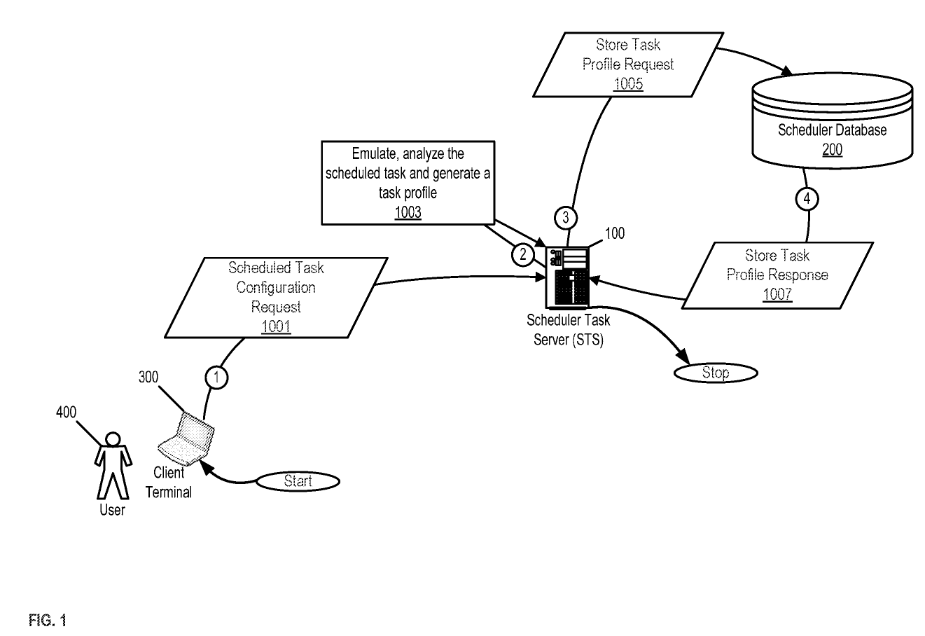

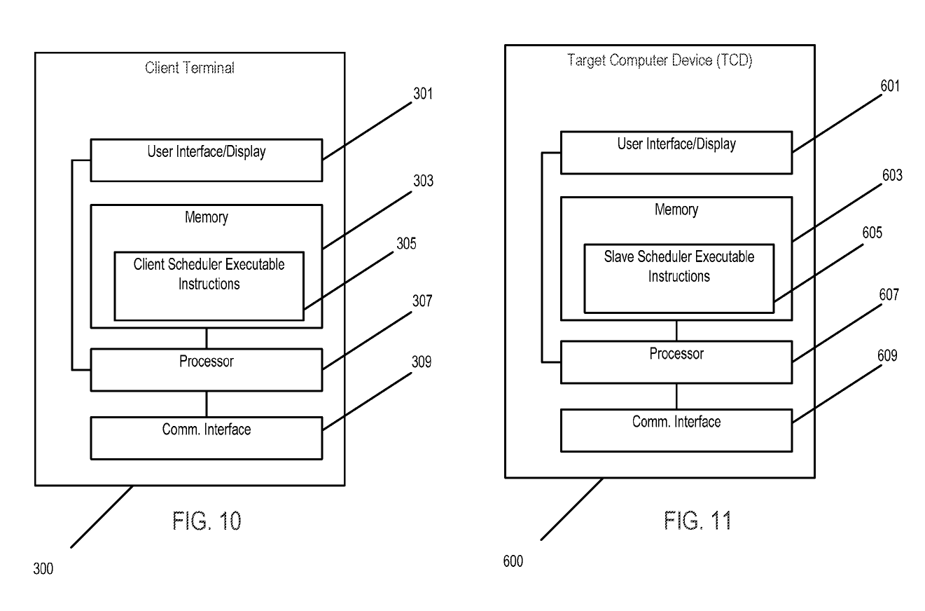

FIG. 1 shows a cross-entity data flow illustrating a user 400 scheduling a task and a scheduler task server/apparatus too receiving and profiling the task. In some implementations, the user 400 in communication with the computer terminal device 300 can send a scheduled task configuration request tool including a task with computer executable instructions to be performed by the STS apparatus 100, a slave computer device, and/or a target computing device (TCD), for example, TCD 600 in FIG. 11.

In some implementations, the scheduled task request 1001 can include a TCD identifier, a time specifying when the task should be executed by the TCD, an indicator of the task's absolute and/or relative priority, a user identification number to uniquely identify a user of the STS, and an email account, phone number and other communication device identifier to receive feedback about the execution of the task. More specifically, a task request 1001 can include numerous fields such as: a time stamp indicating when the task request 1001 was received, a device id identifying the computing device or terminal sending the request, terminal credentials to verify the legitimacy of the requesting terminal, user credentials to validate the legitimacy of the user requesting the scheduled task, and a scheduled task with a task id, a task type, for example task expressed in PHP code, a timestamp indicating when the task should be executed, an identifier corresponding to a computer device which will receive information generated by the task and/or to perform a subtask derived from the task, code with the executable instructions to perform the task, and the like fields.

An example scheduled task request 1001, substantially in the form of an HITP(S) POST message including XML-formatted data, is provided below:

POST /scheduled_task_request.php HTTP/1.1
Host: www.STS.com
Content-Type: Application/XML
<?XML version = “1.0” encoding = “UTF-8”?>
<str_request>

<timestamp>2020-12-12 15:00:00</timestamp>
<device_ID>2027</device_ID>
<user_terminal_credentials>

<password>secretpass1234</password>
<private_key>j341engi648et456#@hnnengywrksxbi</private_key>

</user_terminal_credentials>
<user_credentials>

<user_name>John Doe</user_name>
<user_password>904aA409<user_password>
<user_email>jd@dpartners.com</user_email>

</user_credentials>
<scheduled_task>

<task_ID>2729</task_ID>
<type>PHP</type>
<sched_time>4:00AM</sched_time>
< target_ID>800B</target_ID>
<code>

private function didSCDChangeTier($device)

$serverspace=$device[‘d_serverspace’]/(1024*1024);
if( $device[‘d_useOldOverages’] == 0 ){

.
.
.

</code>
</scheduled_task>

</str_request>

The scheduled task shown above includes a <timestamp> indicating when the task was sent by the client terminal 300; <user_terminal_credentials> including terminal password and terminal private key; <user_credentials> including user name, user password and user email account; and <scheduled-task> wrapping the code or computer executable instructions to be executed by a TCD or slave compute device. In this case the computer executable instructions verify whether or not the TCD has changed its tiered storage and accordingly sets a new storage capacity when appropriate.

In some instances, the STS apparatus 100 can start a sub-process 1003 to emulate the scheduled task on an environment configured with equal or similar properties as the TCD or slave compute device to further generate a task profile. As such, in some implementations, the STS apparatus 100 can extract and emulate the task included in the request and generate a task profile based on data obtained during the emulation. Some of the data that can be obtained from the task emulation include performance metrics, for example, metrics describing the consumed memory and the CPU usage required to execute the tasks by a target device specified in the emulation environment. The obtained metric values and other data included in the scheduled task request 1001 can be utilized by the SIS to generate a corresponding task profile. In other instances, the SIS apparatus 100 can generate the task profile or part of the task profile by calculating the computational expense of the task by itself independently of a target device. For example, the STS apparatus 100 can parse the instructions included in the task and calculate a corresponding algorithmic computational expense by measuring the frequency of instructions or operations known to be inexpensive (e.g., comparisons) and the frequency of instructions or operations known to be expensive (e.g., square roots). Other suitable types of methods to determine computational expense can be equally applied. In yet other instances, the task profile can include the computational expense of a task as a property or function of a target device. For example, the STS can deploy the task to the target device and capture performance or usage metric values of the target device in real-time or near real-time during the execution of the task. The performance or usage metric values captured from a specific TCD while the TCD is executing a scheduled task can be stored in a corresponding task profile.

Once the task profile is generated, the STS apparatus 100 can send a store task profile request 1005 to the scheduler database 200. A script to store a task profile in the scheduler database 200, substantially in the form of PHP: Hypertext source code, is provided below:

private function addTask( ) {

//convert local vars to PendingTask
$this−>PendingTaskInfo−>task = $this−>task;
$this−>PendingTaskInfo−>deviceID = $this−>deviceID;
$this−>PendingTaskInfo−>param = $this−>param;
$this−>PendingTaskInfo−>orderingUser = $this−>Utility−

>getNaturalUsername( );

$remoteIP = $_SERVER[‘REMOTE_ADDR’];
$addedBy = $_SESSION[‘userID’];
appendToLog(‘taskQueue’, “$remoteIP −> Admin UserID:

$addedBy queued task ‘$this−>task’ for device $this−>deviceID
$this−>param”);

if(($this−>PendingTaskInfo−>task==‘’)||($this−

>PendingTaskInfo−>deviceID==‘’))

return(false);

//make sure they have permission to use this task
if($this−>getAvailableResellerTasks($this−

>resellerID,$this−>task) == false){

return false;

}
//insert task
$query = $this−>PendingTaskInfo−

>getQuery(’insertPendingTask’);

$insertArray = $this−>runQuery($query);
//return
if(!$insertArray)

return false;

else

return true;

}

The above example illustrates an implemented function expressed in PHP code. The function comprises the executable instructions to add an entry to a log file. In this case the function can cause the STS to record a pending scheduled task in the scheduler database 200. Specifically, the code verifies if the task has two key fields to be stored in the database. The first key field is a device ID indicating the slave device or TCD that is configured to execute the scheduled task. The second field contains executable instructions to perform the task. In some instances, when either of these two fields is absent, then the function can stop the process and the STS server too can send a failure notification to the user 400 via the client terminal 300 of the failure of the scheduled task configuration request. Additionally, or alternatively, the STS server 100 can send a request to the client terminal 300 for a user or administrator to input the absent fields.

Thereafter, the function can verify if the user requesting to schedule the task has the permissions to execute such a task. Permissions may depend on, for example, the user's role, the type of task and/or the slave or TCD. Again, if the user does not have the corresponding permissions, then the function can stop and the STS server 100 can send a notification to the user 400. The last portion of the function contains instructions to insert elements of a task profile in the scheduler database 200. Depending on whether the profile was stored successfully or not, in the database 200 a flag or other suitable notification can be returned to the STS apparatus 100 indicating the outcome, e.g., at 1007.

The scheduler database 200 can include a relational database to store task profiles in one or more database tables. Thereafter, the scheduler database 200 can send a store task profile response 1007 to the STS apparatus 100 informing the success, failure and/or other status regarding the outcome of the request 1005.

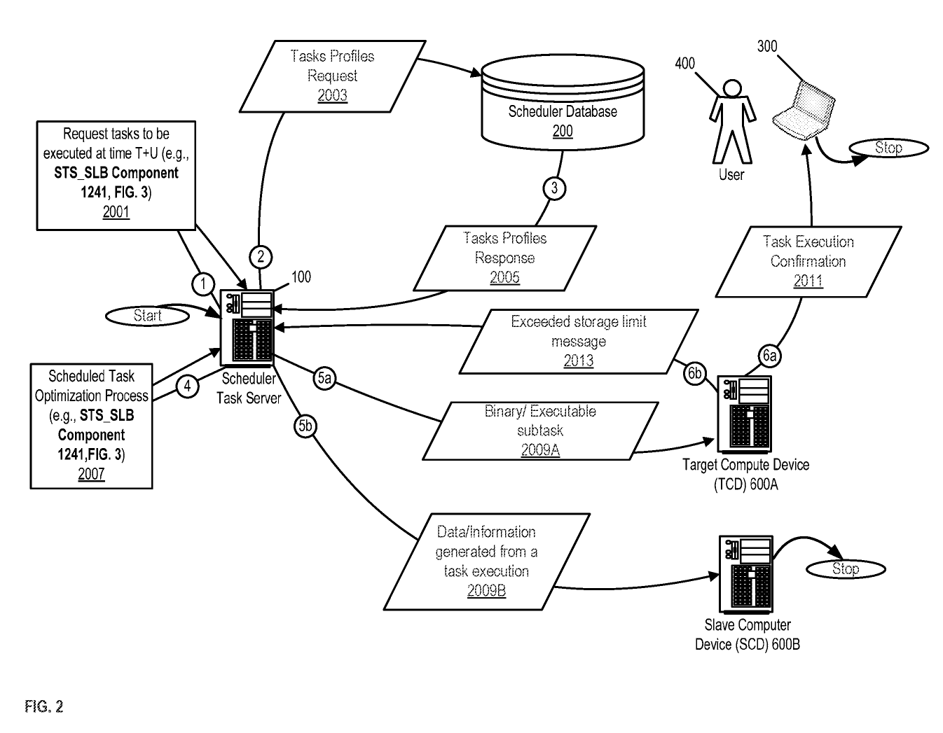

FIG. 2 shows a cross-entity data flow illustrating further aspects of the processes executed by the STS 100 in FIG. 1 to optimize the execution of scheduled tasks and/or to preemptively order tasks to be executed at near-future time period through an STS_SLB Component 1241, in one embodiment. In some implementations, the STS apparatus 100 can periodically execute a background sub-process 2001 as part of the SLB in order to collect task profiles to be executed at a near-future time period. For example, the sub-process 2001 can be executed at the current time T and can include request for the task profiles corresponding to the tasks that are scheduled to be executed at a time or by the time T+U where U can be a time period selected by an STS apparatus 100 administrator and/or an administrator of the trusted network 600A in FIG. 1. Alternatively, U can be a constant time unit programmed as a default value. Thereafter, a task profile request 2003 can be send by the STS apparatus 100 to the scheduler database 200. The scheduler database 200 can then determine a set of task profiles scheduled to be executed at the time T+U and sends the determined set of task profiles to the STS apparatus 100 in a task profile response 2005.

Once the STS apparatus 100 receives the set of tasks profiles in the response 2005, the STS can execute a background sub-process 2007 to determine an execution order for the tasks scheduled to be executed at the time T+U. In some implementations, the scheduled tasks can be configured to be executed by the STS apparatus 100 and propagate or send data and/or information 2009B to a slave computer device (SCD) 600B. Additionally, or alternatively, the STS apparatus too can send a scheduled task as a binary or as a file with computer executable instructions 2009A to the TCD 600A for local execution. In some instances, a master-slave relationship can be appropriate because, for example, the SCD 600B can execute instructions according to the instructions sent by the STS apparatus 100. In other instance where a system is loosely coupled a TCD 600A can be a more appropriate implementation. Notice that either a TCD 600A or the SCD 600B can receive in some instances data as described at 2009A and 2009B. An example of executable subtask instructions 2009A, substantially in the form of PHP: Hypertext source code, is provided below:

private function didSCDChangeTier ($device){

$serverspace = $device[‘d_serverspace’] / ((1024 * 1024) * 1.1);

if( $device[‘d_useOldOverages’] == 0 ){

$serverspace = $device[‘space’] / 1024 / ((1024 * 1024) * 1.1);}
$serverspace = ( $serverspace < 0 ? 0 : $serverspace );

foreach (array(150, 250, 500, 1000) as $tier) {

if ($serverspace <= $tier) {

break;}

}

if ($tier < 500 && $device[‘licCount’] > 2) {

$tier = 500;

}

$tier = ($tier < $device[‘a_originalTier’] ?

$device[‘a_originalTier’] : $tier);
$returnArray[‘newTier’] = $tier;

if ($device[‘a_isGrandfathered’]) {

$returnArray[‘newTier’] =
$device[‘a_currentTier’];

}
return $returnArray;

}

The STS apparatus 100 can send the executable subtask instructions 2009A (e.g., the PHP script shown above) to, for example, determine if the TCD 600A has exceeded its current storage limit. The TCD 600A can execute the computer executable instructions 2009A and thereafter send the message 2013 to the STS apparatus 100 indicating whether the slave computing SCD 600A has exceeded its storage limit or not. The function presented above, can determine whether or not the TCD 600A has exceeded its current storage limit by comparing its currently occupied memory with a threshold, for example, an original tier limit. In some instances when the TCD has exceeded the threshold then, a new tier is generated and reported to the STS apparatus 100 in the message 2013, otherwise the message 2013 contains the original tier.

In some implementations the TCD 600A can send a task execution confirmation 2011 to the terminal 300 notifying to the user 400 whether or not the TCD 600A executed the scheduled task successfully. The confirmation sent at 2011 can also include an output, result or solution generated from the execution of the scheduled task.

Generally, a task execution confirmation 2011 can comprise numerous fields including but not limited to: a time stamp indicating when the execution confirmation was sent to a user terminal; a task ID identifying the task to which the confirmation is related to; user information including user name, user email and/or user cell phone number identifying a user who has subscribed to receive the outcomes of the task; task data including the type of task e.g., PHP function; scheduled execution time; actual execution time; and execution outcome indicating if the task was successfully executed or if there was a failure and/or error during the task execution.

An example of a task execution confirmation 2011, substantially in the form of an HTTP(S) POST message including XML-formatted data, is provided below:

POST /task_execution_information.php HTTP/1.1
Host: 192.168.1.50 // IP of Client Terminal 300
Content-Type: Application/XML
<?XML version = “1.0” encoding = “UTF-8”?>
<te_confirmation>

<timestamp>2020-12-12 17:00:00</timestamp>
<task_ID>2729</task_ID>
<user_information>

<user_name>John Doe</user_name>
<user_email>jd@dpartners.com</user_email>

</user_information>
<task_data>

<type>PHP</type>
<sched_time>4:00AM</sched_time>
<execution_time>4:00AM</execution_time>
<execution_outcome>1</execution_outcome> //1 can mean

successful execution, 2 error/ unsuccessful

<SCD_ID>800B</SCD_ID>

</task_data>
<email_body>

Dear John,
Task [task_ID] executed successfully at
[execution_time]...

</email_body>
</te_confirmation>

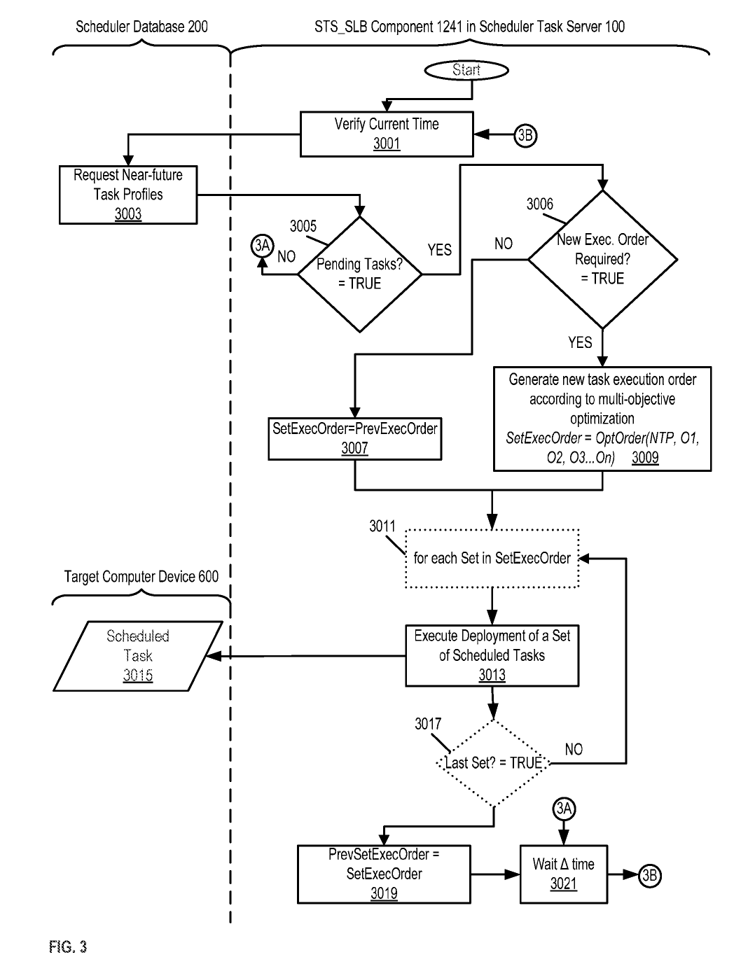

FIG. 3 shows a logic flow of the daemon process shown in FIG. 2. This process preemptively orders tasks to be executed at a future time period (e.g., at T₁=T₀+U, where T₀ is the current time) through an STS_SLB Component 1241. In some implementations, the STS apparatus 100 can run a background STS_SLB daemon or thread process to plan and optimize the execution order of scheduled tasks. The STS_SLB daemon process can start at 3001 by verifying the current time T₀ before sending a request at 3003 to the Schedule Database 200 to retrieve task profiles scheduled to be executed at a near future time period e.g., at T₁. The frequency of the verification process at 3001 can be set according to a user-defined interval or it can be predefined in the STS_SLB Component, for example, the STS_SLB can be configured to verify the current time every 10 seconds and send a query to the Scheduler Database 200 to retrieve tasks scheduled to be performed between the current time T₀ and the a future time T₁. Other implementations of the STS_SLB can include, for example, a background process that remains dormant until the execution time for a scheduled task approaches.

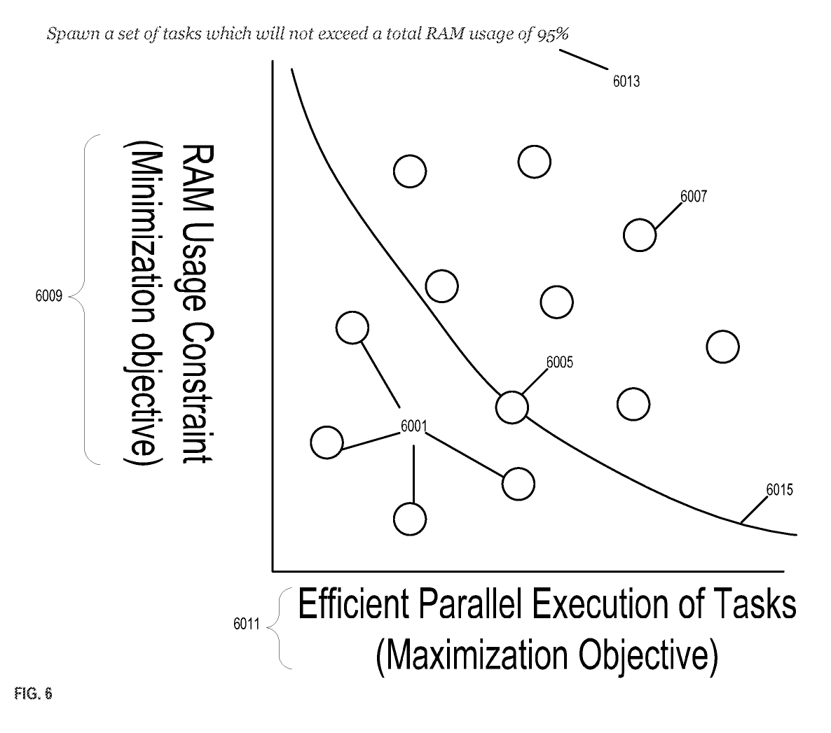

In some implementations, the STS_SLB daemon process can determine at 3005 whether or not one or more scheduled tasks are ready for their execution at time T₁. For example, upon a received response for the request at 3003, the STS_SLB component can determine at 3005 if there are one or more pending scheduled tasks for their execution at time T₁. For example, a conditional statement can be executed at 3005 to determine if there any pending tasks scheduled to be executed at T₁ and/or between T₀ and T₁. In some instances, when there are pending tasks, the STS_SLB component can generate a new task execution order for the pending task or alternatively use an execution order determined at a previous iteration of the daemon process as shown at 3006. For example, in some instances, when a monitored TCD has not shown any performance changes and a previous execution order has been determined on a previous iteration for the pending scheduled tasks the previously determined execution order can be reused as shown at 3007. In other instances the performance of a monitored TCD can show significant performance changes or the number of scheduled tasks to be executed by a TCD could have change, in such cases, the STS_SLB component can generate a new task execution order as shown at 3009. The new task execution order can be generated by calling a function to perform multi-objective optimization process, for example, by calling a function (SetExecOrder=OptOrder(taskProfiles O1, O2, . . . On)) to perform a Pareto analysis as described with respect to FIG. 6 below. The determination of whether or not generate a new execution order or reused a previously generated execution order can be made at 3006.

In some instances, SetExecOrder data structure can store a matrix or a two-dimensional array, containing one or more sets of tasks. Each set of tasks can contain one or more tasks optimized to be executed in parallel by the STS apparatus 100, a TCD and/or a SCD. In some instances, a SetExecOrder data structure can store a solution with two optimization levels (described in detail with respect to FIG. 6) both optimization levels can be performed by the process executed upon a call to the function shown at 3009. For example, a first optimization can be performed to determine sets in which tasks can be grouped for parallel execution. For example Tasks A, B, C, and D can be divided in two sets: Set_={Task_A, Task_C} and Set_2={Task_B, Task_D}. The tasks included in each set can be executed in parallel without violating any rule and/or usage constraint. A second optimization can be performed over the order on which the sets are deployed for execution. For example, SetExecOrder={Set_2, Set_1} or alternatively SetExecOrder={Set_1, Set_2} can each represent a solution. In some implementations an optimal global solution can be identified from a set of alternative solutions through the identification of a Pareto point as explained with respect to FIG. 6.

In some implementations, the STS_SLB can initiate a loop at 3011 to execute the deployment of scheduled tasks at 3013 according to the optimized execution order defined in the structure SetExecOrder. As discussed above, a set of tasks can be deployed in some instances to be executed by a TCD as shown at 3015, a SCD and/or by a processor within the STS. The loop started at 3011 can end once the conditional statement 3017 indicates that all the sets in the SetExecOrder structure are exhausted or deployed. Thereafter, the value(s) stored in the PrevSetExecOrder data structure can be configured to retain the execution order specified in the current SetExecOrder as shown at 3019 to be used in a future instance as shown at 3007. In some implementations, the STS_SLB component can wait for a Δ time at 3021 before starting another iteration of the described process at 3001.

### Profiling and Optimizing the Execution of Scheduled Tasks

In some implementations, the STS apparatus 100 profiles tasks upon reception through an emulation process, an analysis of the code corresponding to an scheduled task and/or based on usage metrics captured by the STS from a TCD while the TCD executed the scheduled task. The information included in a task profile can be used by the STS to identify combinations and permutations of tasks that can be grouped together in a set to be executed in parallel by, for example, a TCD. In some implementations, the STS apparatus 100 can monitor in real-time the execution of a scheduled task by a TCD or during emulation of the scheduled task. Accordingly, usage metric values related to, for example, the execution of Task N, Task X, Task Y, and Task Z can be captured by the STS. Some of these usage metric values can include: (1) execution times Task N=20 milliseconds (ms), Task X=30 ms, Task Y=20 ms, and Task Z=40 ms, and (2) consumption of TCD RAM memory Task N=50%, Task X=20%, Task Y=40%, and Task Z=30%. In such a case, the STS apparatus too can determine, for example, three sets: Set 1 {Task N, Task Y}, Set 2 {Task X, Task Z} and Set 3 {Task Z}. Each set represent the task or tasks that can be run in parallel at some point in time. Accordingly, an execution order can specify to start with the parallel execution of the tasks in Set 1 {Task N,Task Y} at T₀ then, after 20 milliseconds (once both, Task N and Task Y have ended); start the parallel execution of the tasks in Set 2 {Task X, Task Z} at T₂₀ and at T₅₀ the remaining to milliseconds of the execution time of Task Z (started at T+20 msec) are ran as specified in Set 3 ending at T₆₀. This solution takes a total of 60 milliseconds to be executed and a TCD RAM usage of 90% for the time segment defined by (T₀-T₂₀), 50% of RAM usage during (T₂₀-T₅₀), and 30% of RAM usage during (T₅₀-T₆₀).

Another and perhaps better solution is provided by dividing the tasks as follow: Set 1 {Task Y, Task X, Task Z}, Set 2 {Task N, Task X, Task Z} and Set 3 {Task N, Task Z}. Accordingly, an order of execution can be determined starting with the parallel execution of the tasks in Set 1 {Task Y, Task X, Task Z} at T₀, then after 20 milliseconds once Task Y has ended at T₂₀ start the execution of any tasks in Set 2 that are not already running, (e.g., start the execution of Task N), according to this execution order Task X will end its execution at T₃₀ while Task N and Task X will end their execution at T₄₀. The execution order solution of this case takes a total of forty milliseconds to be executed and a TCD RAM usage of 90% for the time segment defined by (T₀-T₂₀), a RAM usage of 100% during the time segment defined by (T₂₀-T₃₀), and a RAM usage of 80% during the time segment defined by (T₃₀-T₄₀).

The aforementioned examples can be defined as a problem with two objectives. The first objective could be to reduce the execution time; the second objective could be to execute as many tasks in parallel as possible as long as the combination of executed tasks does not exceed a permissible TCD RAM usage. To identify an optimal (desired) solution indicating an execution order across numerous combinations, permutations of tasks and sets, and system constraints, the STS apparatus can utilize a multi-objective optimization technique described on below sections of this specification.

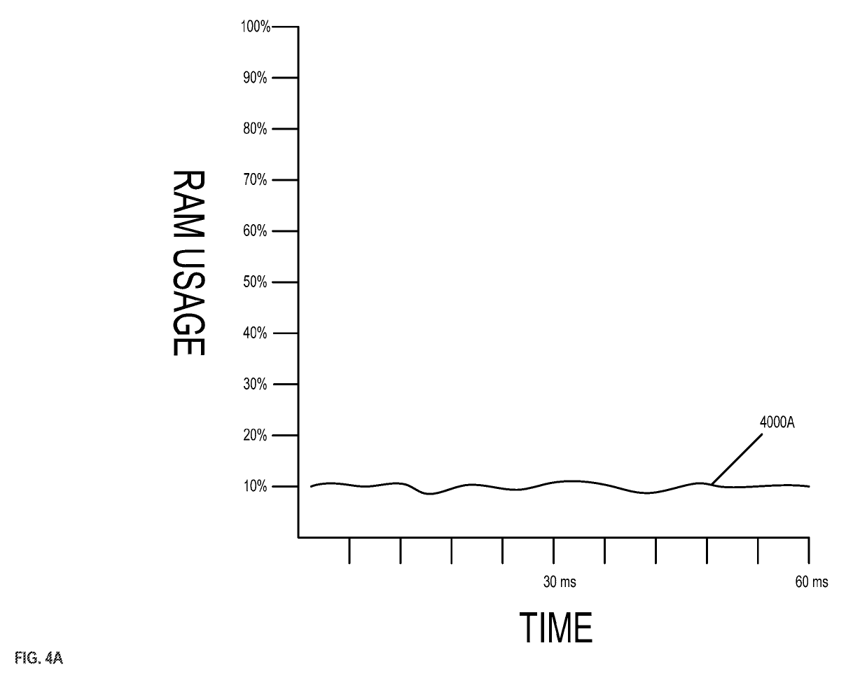

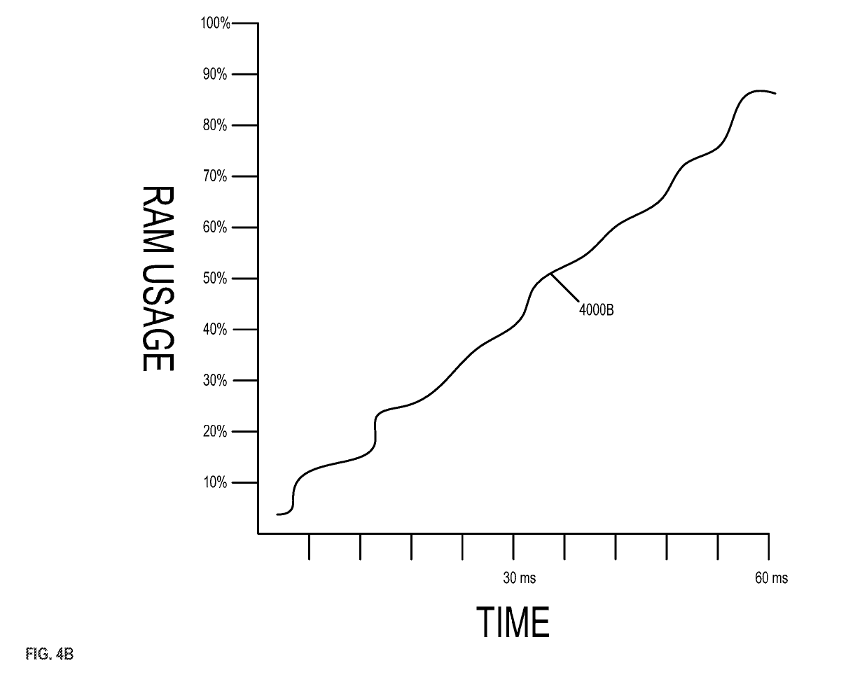

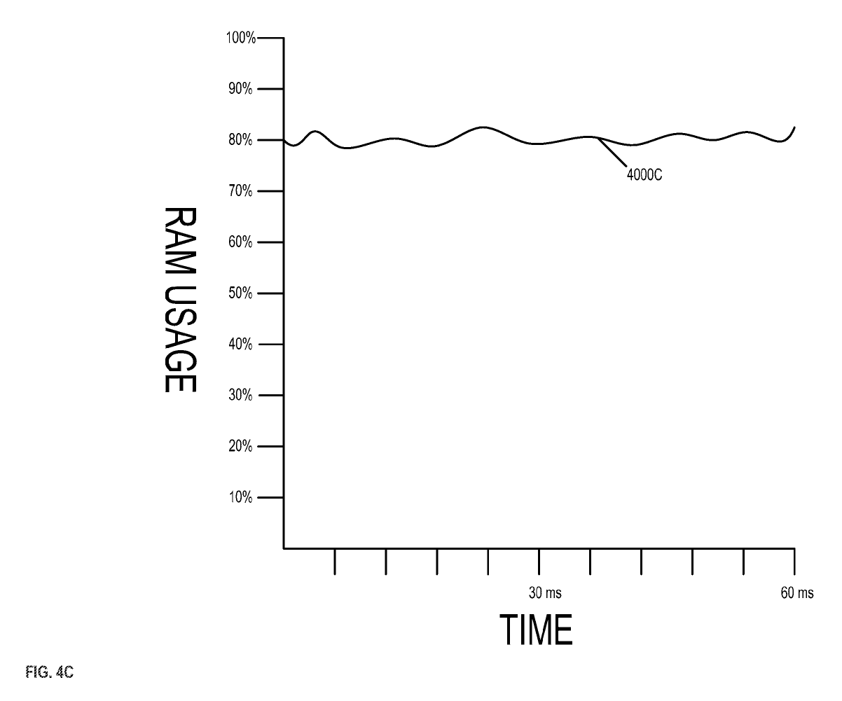

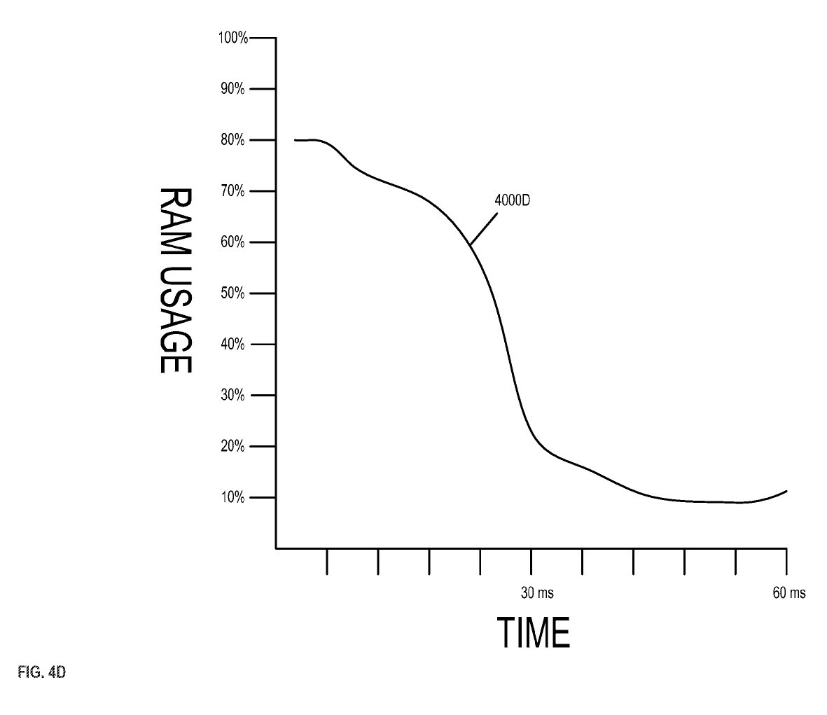

FIGS. 4A-D shows plots of RAM resources consumed over time by four scheduled tasks executed deploy by the STS apparatus 100 and executed by a TCD. The usage data to construct these plots can be acquired during the monitoring of TCDs, or by emulation or simulation of the execution of scheduled tasks. Such data can be stored in a corresponding task profile. FIG. 4A shows a low and constant RAM consumption over time during the execution of a scheduled Task 4A that can be generated or captured by apparatus STS 100. In this instance, the wave 4000A representing the consumption of RAM memory by the scheduled Task 4A shows no variation over time. The RAM usage remains constant at a low level indicating a usage of 10% of the RAM capacity of a TCD.

FIG. 4B shows a wave 4000B of an increasing consumption of RAM memory over time during the execution of a scheduled Task 4B that can be generated or captured by the STS apparatus 100. In this instance, the TCD RAM consumed during the execution of Task 4B increments irregularly over time. The usage of RAM starts around 10% of the total capacity of a TCD and increases in a non-uniform way, by the time 60 ms the RAM usage reaches a consumption of 80% of the TCD RAM capacity.

FIG. 4C shows a wave 4000C representing a high and constant consumption of RAM memory over time during the execution of a scheduled Task 4C that can be generated or captured by the STS apparatus 100. In this instance, the TCD RAM consumed during the execution of the scheduled Task 4C shows no variation over time. The RAM usage value remains constant at a high level indicating a usage of 80% of the TCD RAM capacity.

FIG. 4D shows a wave 4000D representing a decreasing consumption of RAM memory over time during the execution of a scheduled Task 4D that can be generated or captured by the STS apparatus 100. In this instance, the TCD RAM consumed during the execution of the scheduled Task 4D decrements irregularly over time. The TCD RAM usage starts around 80% of the TCD capacity and decreases in a non-uniform way, by a time of 60 ms the TCD RAM usage reaches 10% of the its RAM capacity.

In some implementations, the STS apparatus 100 can generate and/or update a task profile by emulation, simulation and/or by gathering usage metric values from a previous execution of a task. A discussed above in this document, a task profile can include a plurality of fields including but not limited to: a task_id to uniquely identify the task; a type of task, for example, a PHP-based task, a Java based task, C task and the like; a SCD_ID identifying the device which will execute the task and/or will receive data from an executed task; a security level indicating if the task has been deemed safe; an estimated execution time indicating how long would it take to execute the task; RAM usage describing the task RAM consumption over time; CPU usage describing the CPU task consumption over time; properties of a TCD, SCD or other computing device configured to execute the task and other suitable data.

An example scheduled task profile, substantially in the form of an HITP(S) POST message including XML-formatted data, is provided below:

<task_profile>

<task_ID>2729</task_ID>
<type>PHP</type>
<sched_time>4:00AM</sched_time>
<TCD_ID>600A</TCD_ID>
<task_ID>2729</task_ID>
<type>PHP</type>
<sched_time>4:00AM</sched_time>
<SCD_ID>800B</SCD_ID>

<security_level>secure</security_level>

<exec_time>00:00:01:273</exec_time>
<RAM_usage>

[.20,00:00:00:130],[.30,00:00:00:843],[.40,00:00:00:927],[.50,00 :
00:01:073],[.60,00:00:01:100],[.70,00:00:01:273]

</RAM_usage>
<CPU_usage>

[.50,00:00:00:130],[.40,00:00:00:843],[.30,00:00:00:927],[.20,00:
00:01:073],[.10,00:00:01:100],[.05,00:00:01:273]

</CPU_usage>

<code>
private function didSCDChangeTier($device)

$serverspace=$device[‘d_serverspace’]/(1024*1024);
if( $device[‘d_useOldOverages’] == 0 ){

.
.
.

</code>

</task_profile>

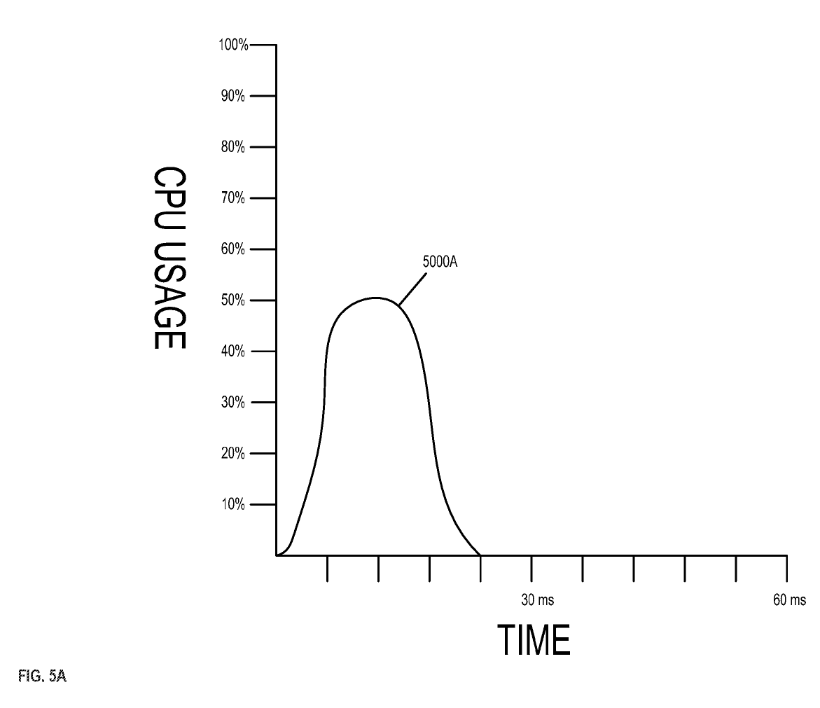

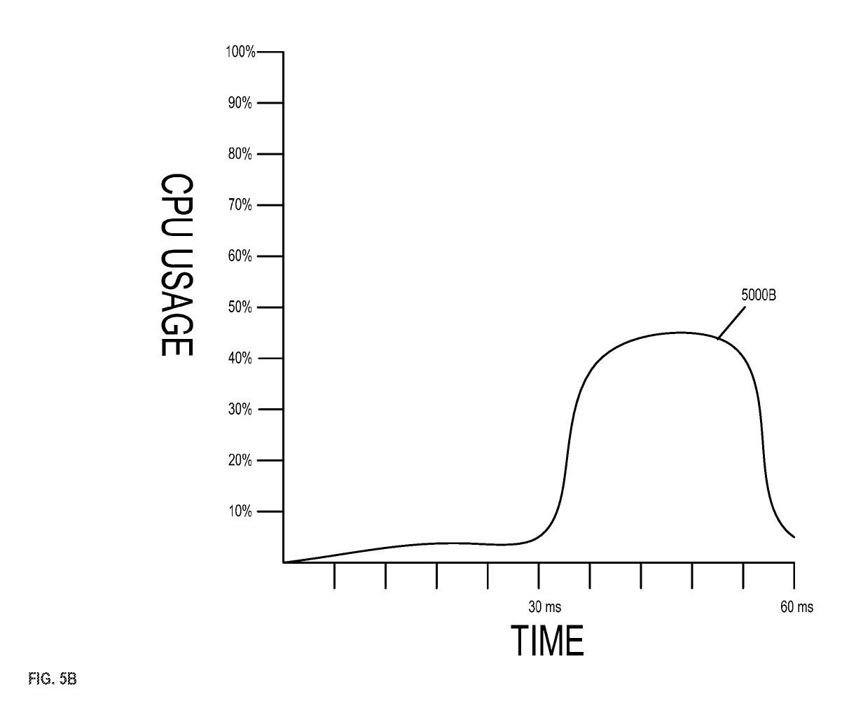

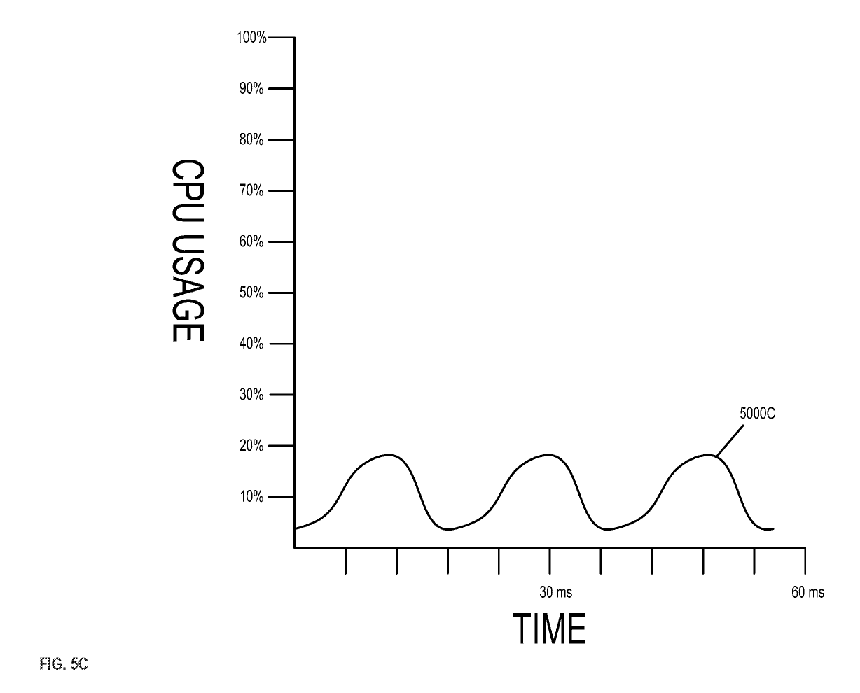

FIGS. 5A-C show examples of plots illustrating central processing unit (CPU) resources consumed over time by three different scheduled tasks executed running on a TCD. Similarly to the plots presented with respect to FIG. 4A-D the usage data to construct these plots can be acquired during the monitoring of TCDs, or by emulation or simulation of the execution of scheduled tasks. Such data can be stored in a corresponding task profile

FIG. 5A shows a wave 5000A representing a vertically symmetrical CPU consumption over time during the execution of a scheduled Task 5A that can be captured or generated by the STS 100. In this instance, the TCD CPU resources consumed during the execution of the scheduled Task 5A show a constant increment of usage over time then, the usage reaches a stable consumption point at around 40% of the TCD CPU capacity. The CPU consumption remains stable over a period of time then, decreases in a constant fashion until the Task 5A terminates.

FIG. 5B shows a wave 5000B displaying a low CPU consumption followed by an abrupt increase of CPU consumption over time during the execution of a scheduled Task 5B in the that can be captured or generated by the STS apparatus 100. In this instance, the TCD CPU resources consumed during the execution of the scheduled Task 5B show a near-to-zero consumption then; it increases abruptly at approximately 30 ms. The CPU consumption remains constant at a stable point at around 40% of the TCD CPU capacity to later drop abruptly at a near-to-zero consumption point until the Task 5B terminates.

FIG. 5C shows a jagged wave 5000C displaying a pattern of CPU consumption over time during the execution of a scheduled Task 5C generated or captured by the apparatus STS 100. In this instance, the TCD CPU resources consumed during the execution of the scheduled Task 5C show a constant pattern, the consumed CPU resources fluctuate approximately between 10% and 20% of the total TCD CPU capacity. The pattern observed in FIG. 5C may indicate, for example, that the Task 5C executes a loop or iterative function with some heavy computational load but which otherwise remains at a low level of CPU resources consumption.

FIG. 6 shows an example of global rules and a multi-objective optimization technique which can be utilized as control strategy to command the parallel execution of scheduled tasks. In some instances, the STS apparatus 100 can have one or more global rules dictating security constraints, resource constraints, performance levels, task processing and execution objectives. For example, a rule can be configured to specify to only “Spawn a set of tasks which will not exceed a total RAM usage of 95%”, example rule 6013. Some rules can have competing objectives and/or can imply multiple objectives. For example, rule 6013 can begin conflict with a general STS apparatus 100 performance objective. An STS apparatus performance objective can be to maximize the efficiency with which some scheduled tasks are completed. In such a case, the STS apparatus 100 can perform a multi-objective optimization technique to resolve conflicts among competing objectives.

In some implementations, the STS apparatus 100 may execute a Pareto analysis to determine a Pareto frontier 6015 defining a border limit separating feasible/satisfactory and infeasible/unsatisfactory solutions to solve a multi-objective problem. For example, a first objective 6009 can be to reduce RAM usage, while a second objective 6011 can be to increase the efficiency of the parallel execution of tasks. An example of infeasible solution can be a solution specifying not to execute any task at a scheduled time; this solution will comply with the first objective but not with the second objective. Other instances of infeasible/unsatisfactory solutions include solutions which exceed a given usage of RAM (e.g., 50% RAM usage). For example, a solution that gives 95% RAM usage can require processing a high number of tasks violating a constraint on RAM usage. It is therefore, deemed to be unsatisfactory and appears on the lower side of the Pareto frontier. In contrast, some solutions can satisfy multiple objectives; these solutions are deemed to be feasible or satisfactory and are shown on the upper side of the Pareto frontier.

In some implementations, each circle in the Pareto distribution can represent a combination or permutation specifying an order to execute scheduled tasks. For example, a permutation can specify the parallel execution of a first set including Task A and Task C followed by the parallel execution of a second set including, Task B and Task D. For another example, a permutation can specify the parallel execution of the second set, followed by the first set. The solutions labeled as 6001 are infeasible because they do not satisfy one or more of the STS apparatus 100 objectives and/or global rules, e.g., they exceed a desired RAM usage threshold and/or capacity. Accordingly, the solutions 6001 appear at the lower side of the Pareto frontier 6015. In contrast, feasible and/or satisfactory solutions, for example, solution 6007 appear on the upper side of the Pareto frontier. Although all the solutions appearing on the upper side of the Pareto frontier 6015 are feasible, some of these solutions can satisfy objectives better than others. In such a case, the STS apparatus 100 can perform an additional analysis to identify the best solution from all the feasible solutions. For example, the Pareto point 6005 represents a compromise execution order satisfying two or more competing objectives in an optimal way.

One technique to identify the optimal solution (i.e., the Pareto point 6005 can be to prioritize one of the multiple objectives and consider it as the primary objective, for example, increasing the number of tasks to executed in private 6011, while the other objectives can be treated as secondary constraints, for example, global rule 6013 and/or objective 6009. In such a case, the STS can favor solutions displaying better or the best achievement of the primary objective as long as the constraint(s) is satisfied. Moreover, each objective can have an associated weight proportional to how relevant the objective is to the overall STS apparatus too performance or TCD or an SCD. The weight associated with each objective and a candidate solution's metric associated with such an objective can be used as parameters for a scoring function to further determine the optimality of each candidate solution. An example of a scoring function can be a function which calculates the summatory of the multiplication of weight by metric values of each candidate solution for the considered objectives. (For a discrete function ƒ(n), the summatory function can be defined by F(n)=Σ_{k=D}ⁿƒ(k).) Thereafter, the STS apparatus 100 can select and implement the candidate solution with the highest score; other more complex functions can be similarly utilized.

In some implementations, the multi-objective optimization can be performed utilizing commercial optimization tools. For example MathWorks MATLAB® Optimization Toolbox can be used to solve multi-objective problems such as goal attainment, minimax, and through the implementation of multi-objective genetic algorithms other suitable multi-objective optimization tools can be similarly used.

### Graphical User Interface for Scheduling Tasks

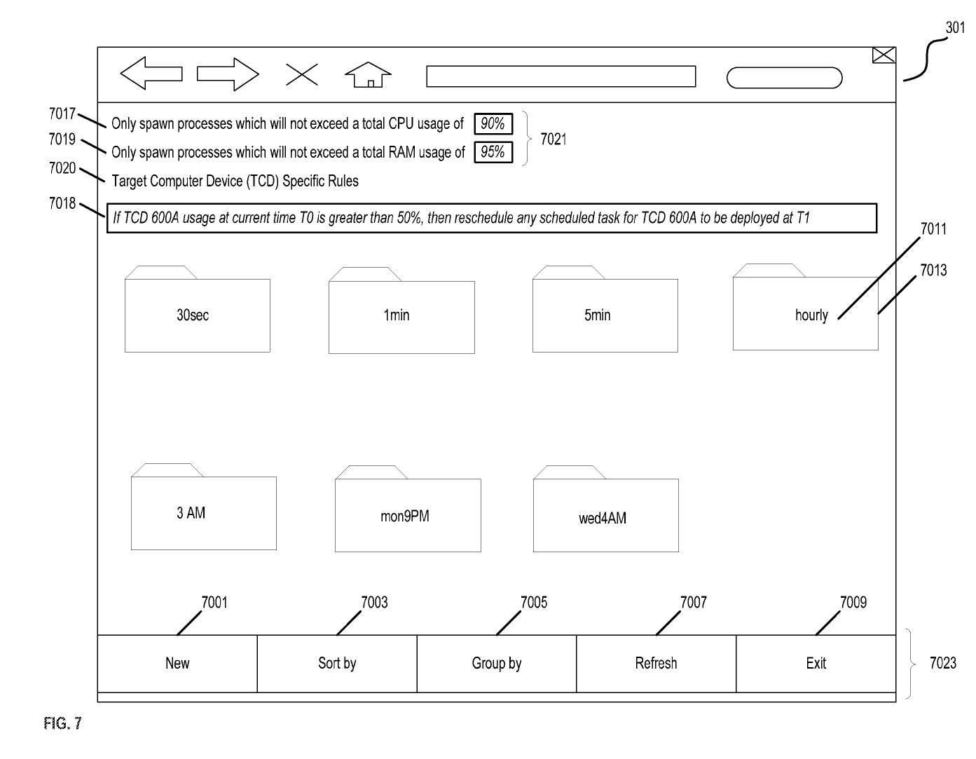

FIG. 7 shows an example seamless GUI to schedule a task to be processed, e.g., by the STS 100 in FIG. 1. In some implementations, the user interface/display 301 in the client terminal apparatus 300 can display a GUI with folder icons (e.g., 7013) representing one or more logic folders. A folder can be labeled with an execution time, files stored inside a folder represent tasks. The user 400 in communication with the client terminal 300 (shown in FIG. 1) can open a folder by inputting an open command through a mouse device and/or a touchscreen, for example, tapping a folder icon 7013 twice or right-clicking on the folder icon. An open folder can display the tasks that are currently programmed to be executed at the time specified on the folder's label. For example, label 7011 indicates that the tasks contained by the folder 7013 will be executed on hourly basis. Time labels can include weekdays, months, a day of a month, hour, and/or minutes, and indicators to specify if the tasks are recurrent tasks, a one-time event task and/or an event that should take place over a specified range of time. For example, throughout the first quarter of the year

In some implementations, the GUI 301 can include a menu bar 7023 with buttons to execute one or more operations on the scheduled tasks folders as described in Table 1 below:

TABLE 1
Example buttons that can be included in the GUI 301.

| Button on FIG. 6 | Command |
|---|---|
| NEW button 7001 | Enables the creation of a folder with a label |
| | specifying a new execution time. |
| SORT BY button 7003 | Sorts the folders by a specified order, for |
| | example, earliest or oldest execution times. |
| GROUP BY button 7005 | Group folders in categories, for example, a |
| | group can include only folders containing |
| | tasks that are executed during AM hours, |
| | while another group can include only |
| | folders that are executed during PM hours |
| | and/or the like grouping criteria. |
| REFRESH button 7007 | Refreshes the GUI 301 to reflect the latest |
| | state of the folder structure. |
| EXIT button 7009 | Exits the GUI 301 |

In some implementations, the NEW button 7001 can be used to create a new folder. For example, if the user 400 wants to set a recurring task to be executed on daily basis at 11 pm, and such a folder does not exist already, the user 400 can click on the NEW button to create the desired folder.

The SORT BY button 7003 allows a user to sort/organize the way the folders appear in the GUI 301. For example, a user may want to view the folders in ascending order, that is, such that the folders with the earliest time labels appear first in the GUI 301 and the folders with the latest time labels appear last.

A GROUP BY button 7005 can be included to group folders in different categories, for example, one group can contain the folders labeled with AM times while a second group can contain the folders labeled with PM times.

A REFRESH button 7007 can refresh or update the GUI 301 content to reflect the latest state of the folder structure. In some implementations, tasks can be added by two or more associated users. For example, the user 400 can be associated with a second user. In such a case, the user 400 can click on the refresh button to view any recent updates made by the second user after the first user loaded the GUI 301. In some implementations, the REFRESH button is not necessary because the update occurs instantaneously on the GUIs of two or more users after one user makes a change in the folder structure. The EXIT button 7009 closes the GUI 301.

In some implementations, the GUI 301 can include one or more text input boxes 7021 to enable a user to specify global rules and/or task execution criteria included but not limited to a threshold constraining CPU usage 7017, a threshold constraining Random Access Memory (RAM) 7019, text box 7018 to specify one or more constrains or TCD specific rules 720 and other suitable rules or criteria.

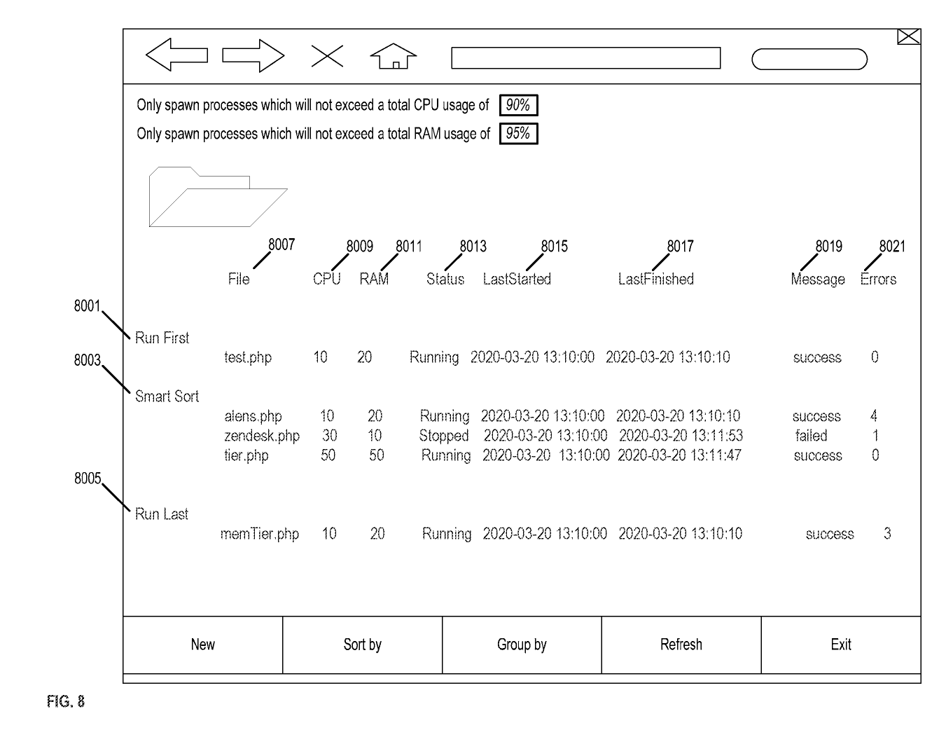

FIG. 8 shows another embodiment of a seamless graphical user interface displaying scheduled tasks contained inside a folder as the ones presented in FIG. 7. The scheduled tasks can be grouped in three main categories. The tasks included in the Run First category 8001 have execution priority over all other categories. A user, for example user 400, can specify an execution order by arranging the order on which the scripts are entered into the script list, for example, the first script in the list will be executed first, followed by the second and so on. The tasks included in the Smart Sort category 8003, will be sorted according to a multi-objective optimization, for example, utilizing the Pareto analysis described with respect to FIG. 6. The tasks included in the Run Last category 8005 have the latest priority level, and similarly to the tasks in the Run First category, the task in the Run Last category are executed in a user-specified order.

In addition to the categories 8001, 8003, and 8005 the scheduled tasks can be displayed with task related information, for example, the file name 8007 containing the computer execution instructions to perform the scheduled task, the peak or average consumption of CPU resources 8009, the peak or average consumption of RAM memory 8011, a scheduled task status 8013, a time stamp indicating when the task was last started 8015, a time stamp indicating when the task was last finished or completed 8017, an outcome message 8019, and the number or errors occurred during the task execution 8021.

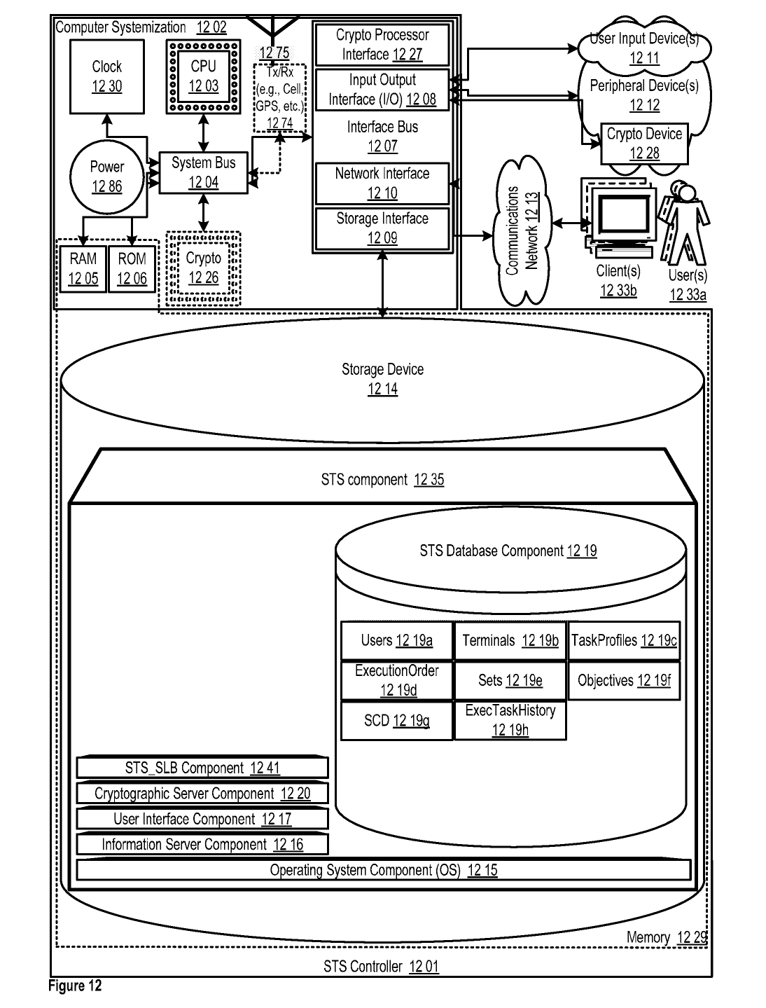

Task related information including the information displayed in FIG. 8 can be kept in the Scheduler Database 200, for example in the ExecTaskHistory table 1219h described below with respect to FIG. 12. The ExecTaskHistory table 1219h can keeps information associated with current and past executions of scheduled tasks.

Scheduling Tasks in a Production Computer Network Via Untrusted Entities

The STS apparatus 100 shown in FIG. 1, daemon process shown in FIGS. 2 and 3, multi-objective optimization shown in FIG. 6, and/or GUI shown in FIG. 7 and FIG. 8 can also be used to allow users on an untrusted network to schedule tasks for execution on a trusted network. This enables a network administrator to make trusted network resources available to computing devices located in an untrusted network without necessarily granting access to all files and commands available in the trusted network to users in the untrusted network. This helps to prevent undesired access to sensitive or personal data stored in the trusted network or operational disruptions to a production computer system in the trusted network.

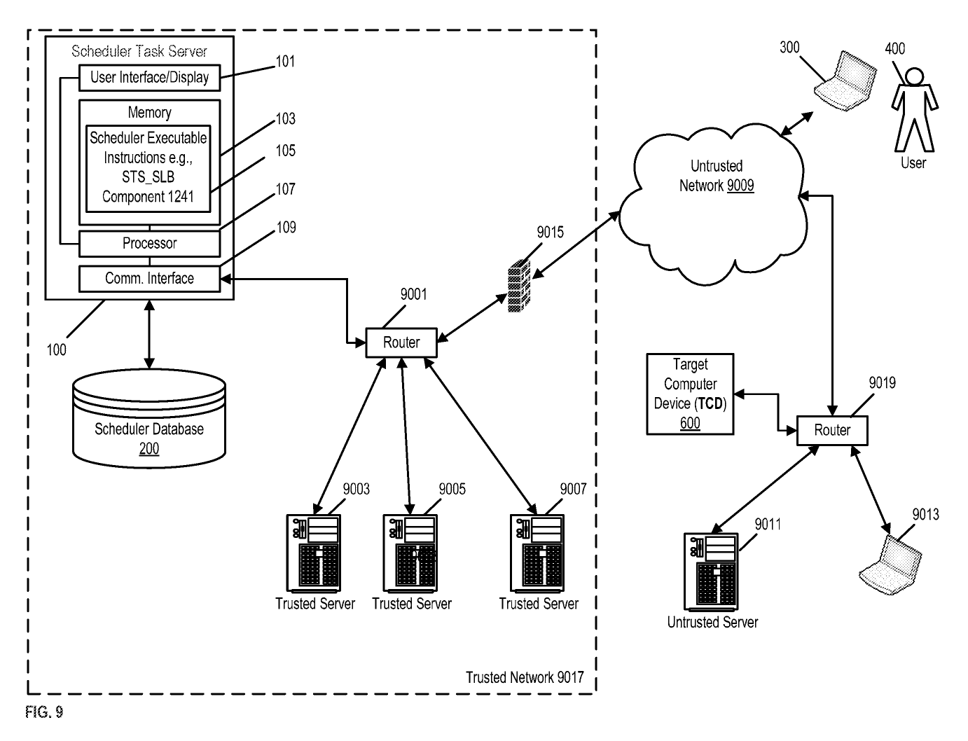

FIG. 9 shows an STS apparatus 100 in a production computer network 9017 receiving a scheduled task from a user 400 on an untrusted network, In some implementations, by using the GUI shown in FIG. 7 and FIG. 8, the user interface 101 can receive commands from a processor 107 physically coupled to a memory 103 comprising a set of scheduler executable instructions 105 which enables a plurality of functions performed by the apparatus 100, including the profiling and management of time-based task and the optimization of parallel execution of tasks. The scheduler apparatus 100 includes a communication interface 109 to communicate with other computer devices, for example the router 9001.

Additionally, the communication interface 109 can receive and transmit data through the gateway router 9000 to one or more devices connected to an untrusted network 9009. In some implementations the STS apparatus 100 can be communicatively coupled to the Scheduler Database 200. The Scheduler Database 200 can store tasks profiles and other system related data. Each task profile can include a task identifier, a task execution time, a task owner, a task description, a task source code, a script, a computer executable or computer interpretable file, a security issue identifier, and/or one or more identifiers corresponding to the devices affected by the task. The apparatus 100 can retrieve task profiles stored in the Scheduler Database 200 upon request to perform one or more operations for example to retrieve the profiles of the tasks due to be executed at a near-future time period.

The STS apparatus 100 can be connected to other computer devices in a trusted network 9017, including trusted servers 9003, 9005, and 9007, and/or gateway router 9001. As understood by those of skill in the art, the trusted network 9017 may be composed of computing devices which can transparently access services, printers, software packages and other trusted network resources in the network 9017. Some of these trusted network resources and services can be limited to the computing devices managed by the trusted network administrators in order to secure sensitive data while maintaining the availability of the network resources.

Access to the trusted network 9017 can be secured by a firewall 9015, which can constrained the access of one or more computing devices connected to the untrusted network 9009, for example, the gateway router 9019 and client terminal 300. As shown in FIG. 9, computing devices on the untrusted network 9009 can be connected to the trusted network 9017 via the firewall 9015, which integrates a collection of security measures to protect the trusted network resources and services. Such security measures may include blacklists, wherein all network packets coming from an untrusted network are allowed except on those cases when the packets fit one or more rules specified in a blacklist. In addition, a whitelist approach can be utilized wherein the firewall rule set is configured to deny access to all the packets coming from an untrusted network unless they are they are specifically allowed in a whitelist.

In some implementations, the firewall 9015 can implement security policies restricting the permissions that users in an untrusted network have over the resources included in a trusted network. As a result, users in untrusted networks, for example, user 400 may not be able to schedule tasks to be performed within the boundaries of the trusted network 9017. The STS apparatus 100 enables the secure implementation of scheduled tasks received from untrusted networks by emulating the task before executing them and profiling according to security levels, execution time, consumption of system resources and the like. If a task is deemed unsecure and/or consumes a high number of resources during emulation, it may be sent back in a message to the requestor, for example, to the user 400 describing the reasons why the task was not scheduled as specified, otherwise, is scheduled for execution.

In some implementations, the STS apparatus 100 can receive scheduled tasks from one or more users. For example, user 400 can use client terminal 300 to set a task to be executed at a user-specified time. The task can thereafter be executed at the STS apparatus 100 and/or further deploy a sub-task to another computer device located on another network. For example, a slave computer device (SCD) 60 can receive via the gateway router 9019, data and/or a sub-task associated with a task received by the STS apparatus 100. The data and/or subtask received by the SCD 600 can affect other computer devices for example; the SCD 600 can receive an operative system update and an execution command to perform the update. Once the updated operative system is installed on the SCD 600 one or more functions in the SCD 600, the untrusted server 9011 and/or the terminal 9013 can change depending on the software update.

FIG. 100 shows an example of system components of a client computer device or terminal computer device. In some implementations, a client terminal apparatus 300 includes a user interface/display 301 and/or a graphical user interface to receive and display information for a user and/or the GUI shown in FIG. 7 and FIG. 8. The user interface 301 can receive commands from a processor 307 physically coupled to a memory 303 comprising a set of scheduler client scheduler executable instructions 305 which enable a plurality of functions performed by the apparatus 300, including the transmission of scheduled tasks to be performed by the STS apparatus 100 and/or another computer device, for example, the shown in FIG. 4. The client terminal apparatus 300 includes a communication interface 309 to communicate with other computer devices, for example the STS apparatus 100.

FIG. 11 shows an example of system components of a target computer device. In some implementations, the TCD 600 can include a user interface/display 601 and/or a graphical user interface to receive and display information for a user. The user interface can receive commands from a processor 607 physically coupled to a memory 603 comprising a set of executable instructions, for example, TCD executable instructions 605 which enables a plurality of functions performed by the apparatus 600, including the reception of scheduled sub-tasks to be performed locally and/or data, for example, an updated version of software currently installed on the TCD 600. The TCD 600 includes a communication interface 609 to communicate with other computer devices, for example the router 9019.

### STS Controller

FIG. 12 shows a block diagram illustrating embodiments of a STS controller. In this embodiment, the STS controller 1201 may serve to aggregate, process, store, search, serve, identify, instruct, generate, match, and/or facilitate interactions with a computer through various technologies, and/or other related data. The STS can, for example, be configured such that the various components described herein execute on a client terminal 300, the scheduler task server 100, and/or the slave computer device 800. Because each component of the STS may be distributed, as described below, the client terminal 3000 and the schedule task server 100 may perform portions of the program logic assigned to them or portions of the program logic normally assigned to the other. In another example, parts of the STS_DAE Component 1021 (described above with respect to FIG. 9 and FIG. 10) can execute on the slave computer device 800 shown. In an alternative configuration, the whole STS_DAE Component 1021 may be installed on scheduler task server 1021 and provide services to client terminal 300 and the slave computer device 800 via the networked program execution capabilities described below.

Typically, users, which may be people and/or other computer systems, may engage information technology systems (e.g., computers) to facilitate information processing. In turn, computers employ processors to process information; such processors 1203 may comprise central processing units (CPUs), microcontrollers, microprocessors, etc. as known in the art of computers. CPUs use communicative circuits to pass binary encoded signals acting as instructions to enable various operations. These instructions may be operational and/or data instructions containing and/or referencing other instructions and data in various processor accessible and operable areas of memory 1229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which may be executed by a CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the STS controller 1201 may be connected to and/or communicate with entities such as, but not limited to: one or more users from user input devices 1211; peripheral devices 1212; an optional cryptographic processor device 1228; and/or a communications network 1213.

The STS controller 1201 may be based on computer systems that may comprise, but are not limited to, components such as: a computer systemization 1202 connected to memory 1229.

### Networks, Servers, Nodes, and Clients

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

### Computer Systemization

A computer systemization 1202 may comprise a clock 1230, central processing unit (“CPU(s)” and/or “processor(s)” (these terms are used interchangeable throughout the disclosure unless noted to the contrary)) 1203, a memory 1229 (e.g., a read only memory (ROM) 1206, a random access memory (RAM) 1205, etc.), and/or an interface bus 1207. Frequently, although not necessarily, these components are interconnected and/or communicate through a system bus 1204 on one or more (mother) board(s) 1202 having conductive and/or otherwise transportive circuit pathways through which instructions (e.g., binary encoded signals) may travel to effectuate communications, operations, storage, etc. The computer systemization may be connected to a power source 1286; e.g., optionally the power source may be internal.

Optionally, a cryptographic processor 1226 and/or transceivers (e.g., ICs) 1274 may be connected to the system bus. In another embodiment, the cryptographic processor and/or transceivers may be connected as either internal and/or external peripheral devices 1212 via the interface bus I/O. In turn, the transceivers may be connected to antenna(s) 1275, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing STS controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, ROM, etc.

The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded, and secures processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the STS controller and beyond through various interfaces. Should processing requirements dictate a greater amount speed and/or capacity, distributed processors (e.g., Distributed STS), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, the technology disclosed herein may be implemented with a microcontroller such as CAST's R8051XC2 microcontroller; Intel's MCS 51 (i.e., 8051 microcontroller); and/or the like. Also, to implement certain features of the disclosed technology, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the STS component collection (distributed or otherwise) and/or features may be implemented via the microprocessor and/or via embedded components; e.g., via ASIC, coprocessor, DSP, FPGA, and/or the like. Alternately, some implementations of the STS may be implemented with embedded components that are configured and used to achieve a variety of features or signal processing.

Depending on the particular implementation, the embedded components may include software solutions, hardware solutions, and/or some combination of both hardware/software solutions. For example, STS features disclosed herein may be achieved through implementing FPGAs, which are a semiconductor devices containing programmable logic components called “logic blocks”, and programmable interconnects, such as the high performance FPGA Virtex series and/or the Spartan series manufactured by Xilinx. Logic blocks and interconnects can be programmed by the customer or designer, after the FPGA is manufactured, to implement any of the STS features. A hierarchy of programmable interconnects allow logic blocks to be interconnected as needed by the STS system designer/administrator, somewhat like a one-chip programmable breadboard. An FPGA's logic blocks can be programmed to perform the operation of basic logic gates such as AND, and XOR, or more complex combinational operators such as decoders or mathematical operations. In at least some FPGAs, the logic blocks also include memory elements, which may be circuit flip-flops or more complete blocks of memory. In some circumstances, the STS may be developed on regular FPGAs and then migrated into a fixed version that more resembles ASIC implementations. Alternate or coordinating implementations may migrate STS controller features to a final ASIC instead of or in addition to FPGAs. Depending on the implementation all of the aforementioned embedded components and microprocessors may be considered the “CPU” and/or “processor” for the STS.

### Power Source

The power source 1286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1286 is connected to at least one of the interconnected subsequent components of the STS thereby providing an electric current to all subsequent components. In one example, the power source 1286 is connected to the system bus component 1204. In an alternative embodiment, an outside power source 1286 is provided through a connection across the I/O interface 1208. For example, a universal serial bus (USB) and/or IEEE 1394 connection carries both data and power across the connection and is therefore a suitable source of power.

### Interfaces and Interface Adapters

Interface bus(ses) 1207 may accept, connect, and/or communicate to a number of interface adapters, conventionally although not necessarily in the form of adapter cards, such as but not limited to: input output (I/O) interfaces 1208, storage interfaces 1209, network interfaces 1210, and/or the like. Optionally, cryptographic processor interfaces 1227 similarly may be connected to the interface bus 1207. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1209 may accept, communicate, and/or connect to a number of storage devices such as, but not limited to: storage devices 1214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1210 may accept, communicate, and/or connect to a communications network 1213. Through a communications network 1213, the STS controller is accessible through remote clients 1233b (e.g., computers with web browsers) by users 1233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed STS), architectures may similarly be employed to pool, load balance, and/or otherwise increase the communicative bandwidth required by the STS controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1210 may be used to engage with various communications network types 1213. For example, multiple network interfaces may be employed to allow for the communication over broadcast, multicast, and/or unicast networks.

Input Output interfaces (I/O) 1208 may accept, communicate, and/or connect to user input devices 1211, peripheral devices 1212, cryptographic processor devices 1228, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like.

One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1211 may include peripheral devices, such as: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1212 may be connected and/or communicate to I/O and/or other facilities of the like such as network interfaces, storage interfaces, directly to the interface bus, system bus, the CPU, and/or the like. Peripheral devices may be external, internal and/or part of the STS controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the STS controller may be embodied as an embedded, dedicated, and/or monitor-less (i.e., headless) device, wherein access would be provided over a network interface connection.

Cryptographic units such as, but not limited to, microcontrollers, processors 1226, interfaces 1227, and/or devices 1228 may be attached, and/or communicate with the STS controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 600 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1229. However, memory is a fungible technology and resource, thus, any number of memory embodiments may be employed in lieu of or in concert with one another. It is to be understood that the STS controller and/or a computer systemization may employ various forms of memory 1229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1229 will include ROM 1206, RAM 1205, and a storage device 1214. A storage device 1214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1229 may contain a collection of program and/or database components and/or data such as, but not limited to: operating system component 1215; information server component 1216; user interface component 1217; STS database component 1219; cryptographic server component 1220; STS_SLB Component 1241; and/or the like (i.e., collectively a component collection). The aforementioned components may be incorporated into (e.g., be sub-components of), loaded from, loaded by, or otherwise operatively available to and from the STS component(s) 1235.

Any component may be stored and accessed from the storage devices and/or from storage devices accessible through an interface bus. Although program components such as those in the component collection, typically, are stored in a local storage device 1214, they may also be loaded and/or stored in other memory such as: remote “cloud” storage facilities accessible through a communications network; integrated ROM memory; via an FPGA or ASIC implementing component logic; and/or the like.

### Operating System Component

The operating system component 1215 is an executable program component facilitating the operation of the STS controller. Typically, the operating system facilitates access of I/O, network interfaces, peripheral devices, storage devices, and/or the like. The operating system may be a highly fault tolerant, scalable, and secure system such as: Unix and Unix-like system distributions (such as AT&T's UNIX; Berkley Software Distribution (BSD) variations such as FreeBSD, NetBSD, OpenBSD, and/or the like; Linux distributions such as Red Hat, Debian, Ubuntu, and/or the like); and/or the like operating systems. However, more limited and/or less secure operating systems also may be employed such as Apple OS-X, Microsoft Windows 2000/2003/3.1/95/98/CE/Millenium/NT/Vista/XP/Win7 (Server), and/or the like.

An operating system may communicate to and/or with other components in a component collection, including itself, and/or the like. The operating system can communicate with other program components, user interfaces, and/or the like. The operating system, once executed by the CPU, may enable the interaction with communications networks, data, I/O, peripheral devices, program components, memory, user input devices, and/or the like. The operating system may provide communications protocols that allow the STS controller to communicate with other entities through a communications network 1213. Various communication protocols may be used by the STS controller as a subcarrier transport mechanism for interaction, such as, but not limited to: multicast, TCP/IP, UDP, unicast, and/or the like.

### Information Server Component

An information server component 1216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HITP); Secure Hypertext Transfer Protocol (HTITPS), Secure Socket Layer (SSL), messaging protocols (e.g., ICQ, Internet Relay Chat (IRC), Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Representational State Transfer (REST) and/or the like.

The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the STS controller based on the remainder of the HTTP request. For example, a request such as http://123.124.125.126/mylnformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FITP communications across port 21, and/or the like. An information server may communicate to and/or with other components in a component collection, including itself, and/or facilities of the like. Most frequently, the information server communicates with the STS database component 1219, operating system component 1215, other program components, user interfaces, and/or the like.

Access from the Information Server Component 1216 to the STS database component 1219 may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the STS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the STS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser. Also, an information server may contain, communicate, generate, obtain, and/or provide program component, system, user, and/or data communications, requests, and/or responses.

### User Interface Component

Computer interaction interface elements such as check boxes, cursors, menus, scrollers, and windows (collectively and commonly referred to as widgets) facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows, web interface libraries such as, but not limited to, Dojo, jQuery UI, MooTools, Prototype, script.aculo.us, SWFObject, Yahoo! User Interface, any of which may be used and provide a baseline and technology for accessing and displaying information graphically to users.

A user interface component 1217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating system component 1215, other program components, and/or the like. The user interface may contain, communicate, generate, obtain, and/or provide program component, system, user, and/or data communications, requests, and/or responses.

### Cryptographic Server Component

A cryptographic server component 1220 is a stored program component that is executed by a CPU 1203, cryptographic processor 1226, cryptographic processor interface 1227, cryptographic processor device 1228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component can facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael (AES), RSA, Secure Hash Algorithm (SHA), Secure Socket Layer (SSL), Secure Hypertext Transfer Protocol (HTTPS), and/or the like.

Employing such encryption security protocols, the STS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the STS component to engage in secure transactions if so desired. The cryptographic component facilitates the secure accessing of resources on the STS and facilitates the access of secured resources on remote systems; i.e., it may act as a client and/or server of secured resources. Most frequently, the cryptographic component communicates with information server component 1216, operating system component 1215, other program components, and/or the like. The cryptographic component may contain, communicate, generate, obtain, and/or provide program component, system, user, and/or data communications, requests, and/or responses.

### STS Database Component

The STS database component 1219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the STS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1219 includes several tables 1219a-h. A Users table 1219a may include fields such as, but not limited to: user_id, first_name, last_name, age, state, address_firstline, address_secondline, zipcode, devices_list, contact_info, contact_type, alt_contact_info, alt_contact_type, and/or the like. A Terminal table 1219b may include fields such as, but not limited to: client_id, client_name, client_ip, client_type, client_model, operating_system, os_version, app_installed_flag, and/or the like. A TaskProfiles table 1219c may include fields such as, but not limited to: task_id, task_name, task_userID, task_clientID, task_scheduledTime, task_modificationTime, task_RAMusage, task_CPU_usage and/or the like. An ExecutionOrder table 1219d may include fields such as, but not limited to: eo_id, eo_setOrder, eo_execTime, and/or the like. An Sets table 1019e may include fields such as, but not limited to: set_id, set_taskID, and/or the like. An Objectives table 1219f may include fields such as, but not limited to: objectve_id, objective_description, objective_upperLevel, objective_lowerLevel and/or the like. An SCD table 1019g may include fields such as, but not limited to: scd_id, scd_name, scd_ip, scd_type, scd_model, operating_system, os_version, and/or the like. An ExecTaskHistory table 1219h may include fields such as, but not limited to: task_id, task_name, task_errors, CPU_usage, RAM_usage, last_started, last_finished, task_outcome and/or the like. Any of the aforementioned tables may support and/or track multiple entities, accounts, users and/or the like.

In one embodiment, the STS database component may interact with other database systems. For example, when employing a distributed database system. In such an embodiment, queries and data access by any STS component may treat the combination of the STS database component results and results from a second segment in a distributed database system as an integrated database layer. Such a database layer may be accessed as a single database entity, for example through STS database component 1219, by any STS component.

In one embodiment, user programs may contain various user interface primitives, which may serve to update the STS. Also, various accounts may require custom database tables depending upon the environments and the types of clients the STS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1219a-h. The STS may be configured to keep track of various settings, inputs, and parameters via database controllers.

The STS database may communicate to and/or with other components in a component collection, including itself, and/or facilities of the like. Most frequently, the STS database communicates with the STS component, other program components, and/or the like. The database may contain, retain, and provide information regarding other nodes and data.

### STS Component

The STS component 1235 is a stored program component that is executed by a CPU. In one embodiment, the STS component incorporates any and/or all combinations of the aspects of the STS that was discussed in the previous figures. As such, the STS affects accessing, obtaining and the provision of information, services, transactions, and/or the like across various communications networks. The features and embodiments of the STS discussed herein increase network efficiency by reducing data transfer requirements the use of more efficient data structures and mechanisms for their transfer and storage. As a consequence, more data may be transferred in less time, and latencies with regard to data processing operations and transactions, are also reduced. In many cases, such reduction in storage, transfer time, bandwidth requirements, latencies, etc., will reduce the capacity and structural infrastructure requirements to support the STS's features and facilities, and in many cases reduce the costs, energy consumption/requirements, and extend the life of STS's underlying infrastructure; this has the added benefit of making the STS more reliable. Similarly, many of the features and mechanisms are designed to be easier for users to use and access, thereby broadening the audience that may enjoy/employ and exploit the feature sets of the STS; such ease of use also helps to increase the reliability of the STS. In addition, the feature sets include heightened security as noted via the Cryptographic components 1220, 1226, 1228 and throughout, making access to the features and data more reliable and secure.

The STS components may transform a plurality of scheduled tasks received from users in untrusted networks into an optimized execution order wherein tasks are executed in parallel according to one or more objectives through a multi-objective optimization process and can generate outputs in one or more slave computer devices located in untrusted networks. In one embodiment, the STS component 1235 takes inputs (e.g., schedule task configuration request 1001, store task profile request 1005, task profile request 2003 and/or the like) etc., and transforms the inputs via various components (e.g., STS_SLB Component 1241, and/or the like), into outputs (e.g., data/information generated from a task execution 2009B, exceeded storage limit message 2013, binary/executable task to be executed by a slave computer device 2009A, and/or the like).

The STS component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery; jQuery UI; MooTools; Prototype; script.aculo.us; Simple Object Access Protocol (SOAP); SWFObject; Yahoo! User Interface; and/or the like), WebObjects, and/or the like. In one embodiment, the STS server employs a cryptographic server to encrypt and decrypt communications. The STS component may communicate to and/or with other components in a component collection, including itself, and/or facilities of the like. Most frequently, the STS component communicates with the STS database component 1219, operating system component 1215, other program components, and/or the like. The STS may contain, communicate, generate, obtain, and/or provide program component, system, user, and/or data communications, requests, and/or responses.

### Distributed STS Components

The structure and/or operation of any of the STS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the STS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, Representational State Transfer (REST), process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. Further, the parsing grammar may be used beyond message parsing, but may also be used to parse: databases, data collections, data stores, structured data, and/or the like. Again, the desired configuration will depend upon the context, environment, and requirements of system deployment.

### CONCLUSION

In order to address various issues and advance the art, the entirety of this application (including the Cover Page, Title, Headings, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented to assist in understanding and teach the claimed principles.

It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various inventive concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently claimed. Applicant reserves all rights in those unclaimed innovations including the right to claim such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A computer-implemented method for scheduling a plurality of tasks configured to be executed by an at least one target computing device, the method comprising:
receiving, at a server, computer-executable instructions to deploy the plurality of tasks at a one or more scheduled times, the plurality of tasks configured to be executed by the at least one target compute device (TCD);
determining a one or more expected usage metric values for each task of the plurality of tasks, the one or more expected usage metric values associated with an at least one of an expected memory usage metric and an expected central processing unit (CPU) usage metric;
calculating an execution order for the plurality of tasks based on a multi-objective optimization, the multi-objective optimization includes a one or more competing objectives associated with the one or more expected usage metric values; and
deploying, based on the one or more scheduled times, the plurality of tasks to the at least one TCD, according to the execution order.

2. The computer-implemented method of claim 1, further comprising:
generating, for each task of the plurality of tasks, a task profile, the task profile includes a target identifier corresponding to the at least one TCD, and an at least one of the one or more expected usage metric values.

3. The computer-implemented method of claim 2, wherein the task profile further includes a task priority level defined by at least one user.

4. The computer-implemented method of claim 3, wherein the multi-objective optimization further includes a one or more competing objectives associated with the task priority level defined by at least one user.

5. The computer-implemented method of claim 2, further comprising:
changing an at least one of the one or more expected usage metric values in the task profile, to an at least one different usage metric value, the at least one different usage metric value recorded during an execution of a task associated with the task profile, the execution of the task performed by the at least one TCD, and corresponds to the target identifier included in the task profile.

6. The computer-implemented method of claim 1, wherein determining the one or more expected usage metric values, further comprises:
calculating an at least one expected usage metric value for an at least one task of the plurality of tasks based on a set of computer-executable instructions to cause the at least one TCD to execute the at least one task, the at least one expected usage metric value calculated independently of any recorded usage metric values of the at least one TCD.

7. The computer-implemented method of claim 1, wherein determining the one or more expected usage metric values further comprises:
calculating an at least one expected usage metric value for an at least one task of the plurality of tasks, based on one or more properties of the at least one TCD associated with the at least one task.

8. The computer-implemented method of claim 1, wherein determining the one or more expected usage metrics values further comprises:
determining an at least one usage metric value for an at least one task of the plurality of tasks based on one or more usage metric values recorded during an execution of the at least one task, the execution performed by the at least one TCD.

9. The computer-implemented method of claim 1, wherein the multi-objective optimization further includes a one or more competing objectives associated with a usage threshold for the at least one TCD, the usage threshold specified by an at least one user.

10. The computer-implemented method of claim 1, wherein calculating the execution order for the execution of the plurality of tasks further comprises:
generating, a one or more sets of tasks, each set of tasks includes one or more tasks selected from the plurality of tasks based on the multi-objective optimization, the tasks configured to be executed in parallel by the at least one TCD.

11. The computer-implemented method of claim 10, wherein calculating the execution order for the execution of the plurality of tasks further comprises:
selecting, a permutation to define an order of the one or more sets of tasks, the permutation selected from a plurality of unique permutations of the one or more sets of tasks based on the multi-objective optimization.

12. The computer-implemented method of claim 1, wherein the server is the at least one TCD.

13. The computer-implemented method of claim 1, wherein the computer-executable instructions to deploy a plurality of tasks at the one or more scheduled tasks are received from a client terminal through an untrusted network.

14. The computer-implemented method of claim 13, wherein the at least one TCD resides in a trusted network.

15. The computer-implemented method of claim 1, wherein the calculated execution order causes the at least one TCD to execute the plurality of tasks in compliance with the one or more competing objectives.

16. An apparatus for scheduling a plurality of tasks configured to be executed by an at least one target computing device, the apparatus comprises:
one or more processors; and
a memory storing instructions which, when executed by the one or more processors, causes the one or more processors to:
receive computer-executable instructions to deploy the plurality of tasks at a one or more scheduled times, the plurality of tasks configured to be executed by the at least one processor of the target compute device (TCD);
determine a one or more expected usage metric values for each task of the plurality of tasks, the one or more expected usage metric values associated with an at least one of an expected memory usage metric and an expected central processing unit (CPU) usage metric;
calculate an execution order for the plurality of tasks based on a multi-objective optimization, the multi-objective optimization includes a one or more competing objectives associated with the one or more expected usage metric values; and
deploy, based on the one or more scheduled times, the plurality of tasks to the at least one TCD, according to the execution order.

17. The apparatus of claim 16, wherein the memory storing instructions which, when executed by the one or more processors, further causes the one or more processors to calculate the execution order for the execution of the plurality of tasks and further:
generate, a one or more sets of tasks, each set of tasks including one or more tasks selected from the plurality of tasks based on the multi-objective optimization, the tasks configured to be executed in parallel by the at least one TCD.

18. The apparatus of claim 17, wherein the memory storing instructions which, when executed by the one or more processors, further causes the one or more processors to calculate the execution order for the execution of the plurality of tasks and further:
select a permutation defining an order for the one or more sets of tasks, the permutation selected from a plurality of unique permutations of the one or more sets of tasks based on the multi-objective optimization.

19. The apparatus of claim 16, wherein the memory storing instructions which, when executed by the one or more processors, further causes the one or more processors to:
generate, for each task of the plurality of tasks, a task profile, the task profile including a target identifier corresponding to the at least one TCD, and an at least one of the one or more expected usage metric values.

20. The apparatus of claim 16, wherein the memory storing instructions which, when executed by the one or more processors, further causes the one or more processors to calculate the execution order for the execution of the plurality of tasks wherein the calculated execution order causes the at least one TCD to execute the plurality of tasks in compliance with the one or more competing objectives.

21-22. (canceled)
